(19) United States
(12) Patent Application Publication
(10) Pub. No.: US 2014/0073303 A1
(43) Pub. Date: Mar. 13, 2014

(54) HISTORIC PERFORMANCE ANALYSIS FOR MODIFICATION OF NEIGHBOR RELATIONS

(71) Applicants: Thomas W. Henderson, Alpharetta, GA (US); Arthur Richard Brisebois, Cumming, GA (US); Fereidoun Tafreshi, Bellevue, WA (US)

(72) Inventors: Thomas W. Henderson, Alpharetta, GA (US); Arthur Richard Brisebois, Cumming, GA (US); Fereidoun Tafreshi, Bellevue, WA (US)

(73) Assignee: AT&T MOBILITY II LLC, Atlanta, GA (US)

(21) Appl. No.: 13/609,026

(22) Filed: Sep. 10, 2012

(51) Int. Cl. H04W 16/00; H04W 36/00

(52) U.S. Cl. 455/418

(57) ABSTRACT

Adjusting RAN performance by adapting cell coverage area can help optimize a wireless communications network. RAN topology can be adapted based on analysis of historical performance of base stations. Analysis of the historical performance of base stations can be performed in the core-network of a wireless carrier rather than distributing the analysis to RAN elements. Analysis can be based on receiving historical information relating to key performance indicators such as call failure rate, call success rate, handover attempt count, handover attempt failure count, etc. Further, analysis can include the application of predetermined rules relating to preferential performance of the base stations. This can facilitate ranking neighboring base stations, adding new base stations, deleting base stations, black/white listing base stations, etc., in neighbor relations data structures, such as automatic neighbor relations structures for self-organizing networks, e.g., eNodeBs in LTE networks.

### TECHNICAL FIELD

The disclosed subject matter relates to radio area network coverage and, more particularly, to adaptive radio area network coverage.

### BACKGROUND

By way of brief background, coverage area conditions for a radio area network (RAN) can be predicated on topological and topographical features of the deployed RAN equipment, including base stations, e.g., NodeB or enhanced NodeB (eNodeB). A RAN can be comprised of a number of cells, each associated with a base station, e.g., a NodeB/eNodeB. Mobile devices can traverse the RAN by sequentially establishing communications links with the base stations. Generally speaking, the closer a base station is to a mobile device, the higher quality the communications link will be, all else being equivalent, because the communications signals between the base station and the mobile device have a shorter distance to traverse; however, numerous other factors can impact the performance of elements of a RAN.

### BRIEF DESCRIPTION OF DRAWINGS

FIG. 1 is an illustration of a system that facilitates modification of neighbor relations based on historic performance of neighbor base stations in accordance with aspects of the subject disclosure.

FIG. 2 is a depiction of a system that facilitates modification of neighbor relations based on historic performance of neighbor base stations and conflict resolution in accordance with aspects of the subject disclosure.

FIG. 3 illustrates a system that facilitates modification of neighbor relations based on historic performance of neighbor base stations, conflict resolution, and coverage area adjustment, in accordance with aspects of the subject disclosure.

FIG. 4 is a graphic of RAN conditions related to modification of neighbor relations based on centralized historic performance analysis of neighbor base stations in accordance with aspects of the subject disclosure.

FIG. 5 illustrates a method facilitating modification of neighbor relations based on historic performance of neighbor base stations in accordance with aspects of the subject disclosure.

FIG. 6 illustrates a method facilitating modification of neighbor relations, including neighbor ranking, based on historic performance of neighbor base stations in accordance with aspects of the subject disclosure.

FIG. 7 illustrates a method for facilitating modification of neighbor relations, including neighbor ranking, neighbor deletion, and neighbor addition, based on historic performance of neighbor base stations, in accordance with aspects of the subject disclosure.

FIG. 8 illustrates a method for facilitating modification of neighbor relations based on historic performance of neighbor base stations conflict resolution, and coverage area adjustment, in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Adjusting RAN performance by adapting cell coverage area can help increase, e.g., optimize, the operating efficiency of a wireless network. Adjusting the selection of neighboring base stations based on the historical performance of base stations can result in improvements in the performance of a wireless communications network. As an example, selecting historically better performing base stations, e.g., better handover success rates, better call success rates, lower dropped call rates, etc., as neighbors can result in selection of base station combinations providing improved performance. As a second example, where an unplanned outage of a base station, e.g., an eNodeB, occurs, adjusting nearby base station coverage areas by selecting historically high performing base stations to provide post-outage RAN coverage can mitigate the effects of the outage.

Conventionally, RAN coverage conditions can be monitored and adapted in a non-automated manner, such as by deploying personnel to go out into the field to measure SNR values across portions of the RAN. Further, collected measurements can be manually subjected to analysis techniques to determine information, such as an SNR map of the RAN, which can then separately be employed in adaptation of the RAN or planning deployment of resources to improve the performance of the RAN. Moreover, modern decentralized control processes that are becoming increasingly common in RAN operations, e.g., Long Term Evolution (LTE) cellular technologies can specify substantially more decentralized operations, such as Automatic Neighbor Relations (ANR) at each eNodeB, than preceding wireless network, e.g., cellular, technologies can create difficulties in employing historical performance analysis and selection process. As such, it can be desirable to provide tools that can determine information that can be employed in adapting coverage area conditions in a more automated manner. Further, it can be desirable to employ a centralized historical performance analysis that can be employed even in a more modern decentralized control environment.

PCIs are widely used to help identify sector carriers, e.g., eNodeBs, because they consume fewer resources to transmit than a truly unique identifier, e.g., global cell identity (GCI) identifiers. As such, there can be instances where two base stations employ the same PCI in overlapping geographic regions resulting in an identification conflict, e.g., a PCI conflict. The conflict relates to each physical sector carrier of a base station having no more than one neighbor base station using a specific PCI. Where a serving base station has two or more neighbor base stations with the same PCI the serving base station can be unable to identify which neighbor base station to transfer a user equipment to during an event such as a handover. Ultimately, the identification conflict can result in the handover failing, because the two potential handover candidate base stations are not distinguishable from each other based on the PCI. Employing historical performance analysis can allow for selection of historically better performing base stations in a PCI conflict condition.

Adapting cell coverage area in an automated manner, such as by integration with planning components and management components can be employed to, for example, anticipate future deployment of base stations to improve coverage areas, prioritization of base stations to improve coverage balance, etc. Historical information on coverage area patterns of base stations in a RAN can be employed, for example, to perform analysis of statistical coverage conditions for cells in a RAN, analysis of coverage areas as they relate to performance metrics, analysis of coverage areas with regard to specific event such as handovers, etc.

Mobile reporting components, e.g., user equipments (UEs), can be used to report detected base stations to automatic neighbor relations (ANR) components to facilitate selection of neighboring base stations in accordance with selection criteria and rules. In an aspect, UEs can report detected PCIs. Where an identification conflict occurs, historical performance analysis for modification of neighbor relations can be employed to select preferential neighboring base stations. Further, the automated collection of historical performance information to analyze RAN coverage conditions can facilitate adaptation of a RAN based on the historical performance information. In an aspect, adaptation of the RAN can include prioritization of base stations in neighbor relations technologies, e.g., Automatic Neighbor Relation (ANR) detection for self-organizing networks (SON) in Long Term Evolution (LTE) wireless radio technologies, etc. This can further apply to ranking new potential neighbors. This can also apply to ranking existing neighbors, e.g., for preferential selection, retention, deletion, etc. Still further, historical performance information can be employed in RAN planning systems to promote evolution of RAN coverage according to one or more rules. Similarly, historical performance information can be employed for other purposes such as throwing alerts when RAN coverage diverges sufficiently from established parameters, deployment of maintenance services, sourcing information employed in automated mechanical adjustment of elevation, azimuth, or transmit power levels of base stations, etc., without departing from the present scope of the disclosure. The centralized analysis of historical performance information can be cooperative with other decentralized control processes that are expected to become more common as wireless radio control systems evolve, such as facilitating the analysis of distance information at individual eNodeBs in an LTE technology that can facilitate various aspects of a SON including self-healing and self-optimization by cooperation between eNodeBs.

In an aspect, neighbor relations between base stations can relate to neighbor relations between sector carriers of the base stations. Sector carriers can include one or more radios embodying one or more radio access technologies. Further, sector carriers can include one or more radios operating at one or more frequencies. A radio can include one or more antenna. As such, sector carriers of a base station can be separately associated with neighbor relations information associated with a relationship between said sector carriers. As an example, base station “A” can serve several sectors, such as sectors 1 to 3. A second base station, “B”, can serve several sectors, such as sectors 4 to 9. Neighbor relations can be between the radios of the base stations serving specific sectors, for example, between the radios serving sector A-2 (base station A, sector 2) and sector B-9 (base station B, sector 9), etc. In some embodiments, neighbor relations information for a base station can include, for example, neighbor relations information for one or more sector carrier pairs.

Where for one base station it is not permissible to have neighbor relationships towards two other base stations employing the same PCI, modification of the neighbor relations can be based on historical performance information. As an example, when a UE detects a new neighbor base station with the same PCI of an existing neighbor base station, the UE can have already entered the overlapping coverage of the new neighbor base station. If handover does not occur, the new neighbor base station can become an interferer in the downlink direction and the UE can become an uplink interferer towards the new neighbor. This example scenario can lead to dropped calls. However, when the new neighbor is detected, if the UE reports the new neighbor back towards the serving base station, then centralized historical performance information can be employed to selectively retain high performing base stations rather than adopting the newly detected base station, drop poor performing base stations in favor of the newly detected base station, etc. Centralized historical performance information modification of neighbor relations, e.g., the selection order of base stations as neighboring base stations, can include neighbor prioritization, neighbor deletion, neighbor addition, alarm conditions, etc.

The following presents simplified example embodiments of the disclosed subject matter in order to provide a basic understanding of some aspects of the various embodiments. This is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an embodiment, a system can include a processor and memory. The processor can facilitate the execution of computer-executable instructions stored on the memory. The execution of the computer-executable instructions can cause the processor to receive radio information related to identification of a radio in a wireless communications system. The processor can further receive historical performance information related to the radio and related to a performance indicator. Based on an analysis of the historical performance information, the processor can determine an update for neighbor base station relation information to facilitate adaptation of a coverage area of the wireless communication system based on relation information for a set of neighbor base station relations. The processor can also facilitate access to the update for the neighbor base station relation information.

In another embodiment, a method can include receiving, by a system including a processor, radio identification information for a base station of a wireless communications network. The base station can be a neighbor base station to a serving base station. The method can further include receiving historical performance information related to the base station and related to a performance indicator. An update for a neighbor base station relation information can be determined, based on analysis of the historical performance information, to facilitate adaptation of a coverage area of the wireless communication system based on relation information for a set of neighbor base station relation. The method can facilitate access to the update for the neighbor base station relation information.

In a further embodiment, a device can include a memory storing computer-executable instructions and a processor that facilitates execution of the computer-executable instructions. These instructions can cause the processor to receive initial neighbor base station relation information, which can be related to a base station of a wireless communications network. The base station can also be a neighbor base station to a serving base station. The processor can further receive historical performance information related to the base station. An update for neighbor base station relation information can be determined, based on analysis of the historical performance information, to facilitate adaptation of a topology of the wireless communication system based on a set of neighbor base station relations. The processor can then facilitate access to the update for the neighbor base station relation information.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

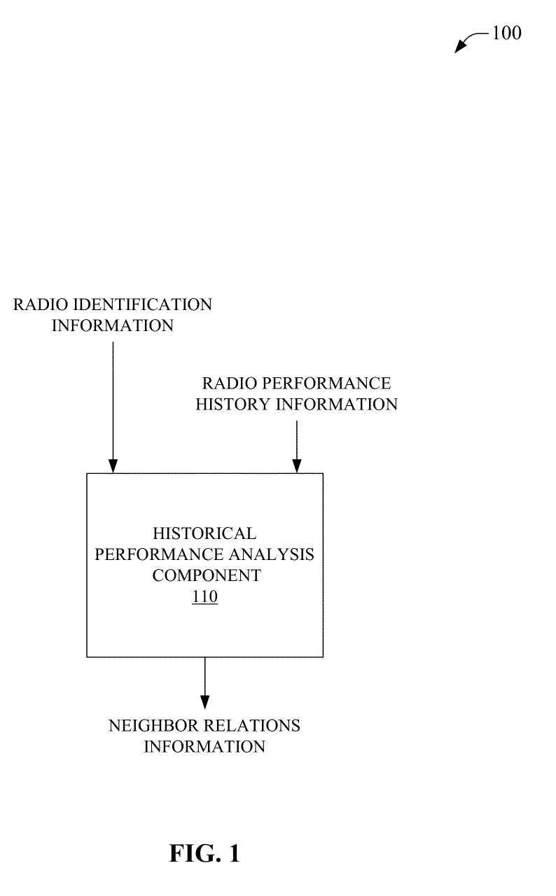

FIG. 1 is an illustration of a system 100, which facilitates modification of neighbor relations based on historic performance of neighbor base stations in accordance with aspects of the subject disclosure. System 100 can include centralized historical performance analysis component (HPAC) 110. HPAC 110 can receive radio identification information. Radio identification information can include identification information for a wireless network base station, e.g., an eNodeB, etc. Identification information can include a PCI, a GCI, etc.

Radio identification information can further include neighbor relations information, e.g., neighbor base station relation information such as an ANR data structure in an LTE environment, etc. An ANR data structure can include information describing the topological relations of neighbor base stations of a wireless communications network. An ANR data structure can be, for example, in the form of a list, a table, etc. As an example, an ANR table can include information describing the topology of base stations neighboring a serving base station. Where, in the example, there are several neighbor base stations, the ANR table can include the preferential selection order of the neighbor base stations to preferentially select neighbor base stations for UE handover as a UE exits the coverage area of a serving base station. Selection of a high performing base station for handover can decrease the likelihood that the handover will fail severing the communication link with the UE.

Moreover, HPAC 110 can receive radio performance history information. Radio performance history information can include historical performance information for a base station of a wireless communications network. In an aspect, HPAC 110 can employ received radio identification information to request radio performance history information corresponding to an identified base station. In an embodiment, radio performance history information can be received at HPAC 110 from a data store that is local or remote to HPAC 110. As an example, radio performance history information can be stored on a wireless communications network core component, e.g., a component in a control center rather than in an eNodeB, etc. As a further example, radio performance history information can be stored on a third-party server, e.g., a service provider working in conjunction with a wireless communications network carrier, etc.

HPAC 110 can analyze radio performance history information to determine neighbor relations information, e.g., neighbor base station relations information. Analysis by HPAC 110 can be related to a base station identified in radio identification information. As such, HPAC 110 analysis can be related to base stations included in an ANR data structure. HPAC 110 analysis can include analysis to determine, for example, a high performing base station, ranking a base station, determining a poor performing base station, identifying a base station for a ‘black list’, e.g., a base station that should be avoided as a neighbor where available, or a ‘white list’, e.g., a base station that should be included as a neighbor where available, etc.

Historical performance analysis can employ nearly any level of temporal granularity and nearly any combination of temporal periods. As examples, historical performance analysis can be based on weekdays, mornings, weekends, holidays, etc. As further examples, historical performance analysis can be based on granularities of seconds, minutes, hours, days, weeks, months, etc. Furthermore, historical performance analysis can be event driven, for example, for weather events, sporting events, social events, emergency events, power outages, etc. As a more specific non-limiting example, a historical performance analysis can be employed to determine historically high performing base stations over a 10-day period from every power outage in the coverage area for the last 2 years to provide insight into ranking neighbor base stations in an ANR data structure when a power outage occurs. In this specific example, base stations connected to emergency power supplies, such as those at hospitals or government facilities, can historically continue to operate in a power outage situation where residential base stations, such as femto-cells, micro-cells, etc., can fail. Analysis of these example historical performances can facilitate neighbor relations rankings to preferentially select base stations that continue to perform in a power outage. As such, where a power outage occurs, neighbor relations information can be update to reflect historically high performing base stations in response to the power outage condition.

In an aspect, historical performance analysis can employ key performance indicators (KPIs). KPIs can include, but are expressly not limited to, call failure rate, call success rate, handover attempt count, handover attempt failure count, load indicia, etc. Further, historical performance analysis can include weighting. Weighting can be applied to individual KPIs, to combined KPI analysis, or combinations thereof. As an example, a weighting can decrease the effect of a historical load analysis where the load indicia is stale, e.g., older than a predetermined age. Similarly, for example, a weighting can increase the effect of a historical performance analysis of both call success rate and handover attempt failure rate. Numerous other KPIs are not enumerated for clarity and brevity though all current or future KPIs are considered within the scope or the subject disclosure.

In an aspect, profiles of base stations can be developed based on historical performance analysis. A base station profile can be received in response to identification of a base station by way of receiving radio identification information at HPAC 110. The use of a profile can facilitate rapid employment of previously computed historical performance analysis for the indicated base station. Centralized historical performance analysis can readily compile profiles for one or more base stations in a RAN. These base station profiles can then be readily accessed to modify neighbor reactions information by way of HPAC 110. Centralization of profile compilation can be advantageous over distributed profile development, e.g., development of profiles at each eNodeB for neighbors, in that, for example, base station profiles are not duplicated across multiple base stations, a base station profile will be the same even when accessed by multiple requestors (no synchronization of profile instances among different base stations), etc. A centralized profile can also reflect more complete analysis of relevant information in that the historical performance of the base station can be compiled based on the interaction of the base station with numerous neighbor base stations in contrast to a local profiles at each eNodeB that can be subject to more limited access to information, e.g., only basing the local profile on interaction with a subset of all the neighbor base stations to the profiled base station.

HPAC 110 can determine neighbor relations information. Neighbor relations information can be employed to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc.

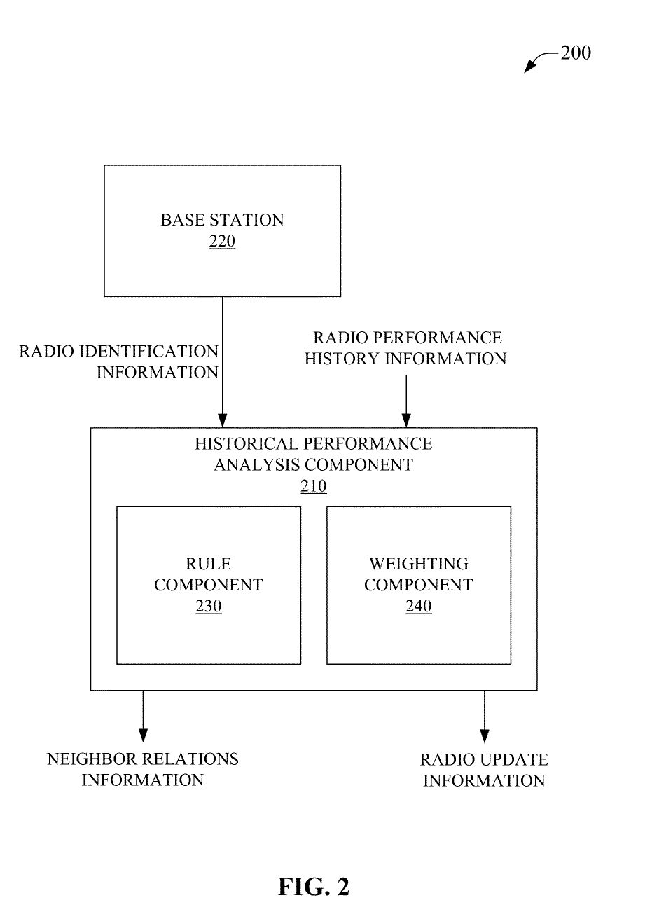

FIG. 2 is a depiction of a system 200 that can facilitate modification of neighbor relations based on historic performance of neighbor base stations and conflict resolution in accordance with aspects of the subject disclosure. System 200 can include HPAC 210. HPAC 210 can receive radio identification information from base station 220. Base station 220 can be an eNodeB of a wireless communications network such as a cellular network. Radio identification information can include identification information for a wireless communications network base station. Radio identification information can further include neighbor relations information.

HPAC 210 can receive radio performance history information. Radio performance history information can include historical performance information for a base station of a wireless communications network. In an aspect, HPAC 210 can employ received radio identification information to request radio performance history information corresponding to an identified base station, e.g., base station 220. In an embodiment, radio performance history information can be received at HPAC 210 from a data store that is local or remote to HPAC 210.

HPAC 210 can analyze radio performance history information to determine neighbor relations information, e.g., neighbor base station relations information. Analysis by HPAC 210 can be related to a base station identified in radio identification information, e.g., base station 220, neighbors of base station 220 (such as those in an ANR list), etc. As such, HPAC 210 analysis can be related to base stations included in an ANR data structure.

HPAC 210 can include rule component 230. Rule component 230 can facilitate employing rules to effect a historical performance analysis. Rule Component 230 can include a rule engine, not illustrated, that can generate a rule for analysis of radio performance history information. Rule component 230 can also facilitate receiving a rule related to the analysis of radio performance history information. In an aspect, rules sets can be received by rule component 230. Receiving rules at rule component 230 can facilitate updating the analysis of radio performance history information. Rules, for example, can relate to analysis to determine a high performing base station, ranking a base station, determining a poor performing base station, identifying a base station for a ‘black list’ or a ‘white list’, etc. Historical performance analysis can employ nearly any level of temporal granularity and nearly any combination of temporal periods. Historical performance analysis can employ KPIs that can include call failure rate, call success rate, handover attempt count, handover attempt failure count, load indicia, etc.

HPAC 210 can further include weighting component 240. Weighting component 240 can facilitate application of weighting to individual KPIs, to combined KPI analysis, or combinations thereof. Weighting can increase or decrease the effect of a KPI in a historical load analysis

In a further aspect, HPAC 210 can facilitate the determination of profiles of base stations based on historical performance analysis. A base station profile can be received in response to identification of a base station by way of receiving radio identification information at HPAC 210. The use of a profile can facilitate rapid employment of previously computed historical performance analysis for the indicated base station.

HPAC 210 can determine neighbor relations information. Neighbor relations information can be employed to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc.

HPAC 210 can further determine radio update information. Radio update information can be used to update radio information, including radio identification information, radio parameters such as elevation/azimuth/power, etc. As an example, radio update information can include designation of a new PCI for a base station to facilitate resolution of a PCI conflict.

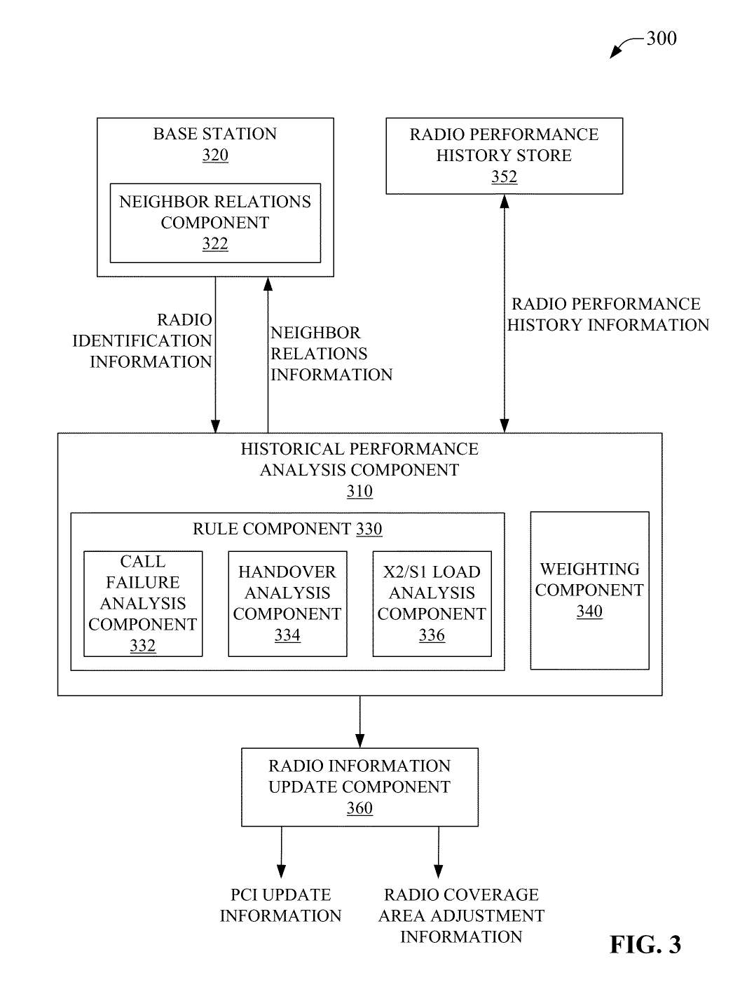

FIG. 3 illustrates a system 300 that facilitates modification of neighbor relations based on historic performance of neighbor base stations, conflict resolution, and coverage area adjustment, in accordance with aspects of the subject disclosure. System 300 can include HPAC 310. HPAC 310 can receive radio identification information from base station 320. Base station 320 can be an eNodeB of a wireless communications network such as a cellular network. Radio identification information can include identification information for a wireless communications network base station. Base station 320 can further include neighbor relations component 322. Neighbor relations component 322 can facilitate access to neighbor relations information for base station 320. As such, radio identification information can further include neighbor relations information. HPAC 310 can determine neighbor relations information. Neighbor relations information can be employed to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc. Neighbor relations information can be received by base station 320 by way of HPAC 310, as illustrated. Neighbor relations information can be employed by neighbor relations component 322 to update neighbor relations information for base station 320.

HPAC 310 can also include radio performance history store 352. Radio performance history store 352 can facilitate access to radio performance history information. As such, HPAC 310 can receive radio performance history information by way of radio performance history store 352. Radio performance history information can include historical performance information for a base station of a wireless communications network. In an aspect, HPAC 310 can employ received radio identification information to request radio performance history information corresponding to an identified base station, e.g., base station 320. In an embodiment, radio performance history store 352 can be local or remote to HPAC 310.

HPAC 310 can analyze radio performance history information to determine neighbor relations information, e.g., neighbor base station relations information. Analysis by HPAC 310 can be related to a base station identified in radio identification information, e.g., base station 320, neighbors of base station 320 (such as those in an ANR list by way of neighbor relations component 322), etc. As such, HPAC 310 analysis can be related to base stations included in an ANR data structure.

HPAC 310 can include rule component 330. Rule component 330 can facilitate employing rules to effect a historical performance analysis. Rule Component 330 can include a rule engine, not illustrated, that can generate a rule for analysis of radio performance history information. Rule component 330 can also facilitate receiving a rule related to the analysis of radio performance history information. In an aspect, rules sets can be received by rule component 330. Receiving rules at rule component 330 can facilitate updating the analysis of radio performance history information.

Further, rule component 330 can include call failure analysis component 332. Call failure analysis component 332 can include one or more rules for historical performance analysis related to call failure corresponding to base station 320 or neighbors thereof, e.g., by accessing a neighbor relations data structure, such as an ANR list, for a list of neighbors to base station 320.

Additionally, rule component 330 can include handover analysis component 334. Handover analysis component 334 can include one or more rules for historical performance analysis related to UE handovers corresponding to base station 320 or neighbors thereof, e.g., by accessing a neighbor relations data structure, such as an ANR list, for a list of neighbors to base station 320.

Moreover, rule component 330 can include X2/S1 load analysis component 336. X2/S1 load analysis component 336 can include one or more rules for historical performance analysis related to load conditions corresponding to base station 320 or neighbors thereof, e.g., by accessing a neighbor relations data structure, such as an ANR list, for a list of neighbors to base station 320.

The rules employed by rule component 330, for example, can relate to analysis to determine a high performing base station, ranking a base station, determining a poor performing base station, identifying a base station for a ‘black list’ or a ‘white list’, etc. Historical performance analysis can employ nearly any level of temporal granularity and nearly any combination of temporal periods. Historical performance analysis can employ KPIs that can include call failure rate, call success rate, handover attempt count, handover attempt failure count, load indicia, etc.

HPAC 310 can further include weighting component 340. Weighting component 340 can facilitate application of weighting to individual KPIs, to combined KPI analysis, or combinations thereof. Weighting can increase or decrease the effect of a KPI in a historical load analysis

In a further aspect, HPAC 310 can facilitate the determination of profiles of base stations based on historical performance analysis. A base station profile can be received in response to identification of a base station by way of receiving radio identification information at HPAC 310. The use of a profile can facilitate rapid employment of previously computed historical performance analysis for the indicated base station.

HPAC 310 can be communicatively coupled to radio information update component 360. Radio information update component 360 can determine radio update information. In an aspect, radio update information can be used to update radio identification information such as PCI information by facilitating access to PCI update information. In another aspect, radio update information can be used to update radio parameters such as elevation/azimuth/power, etc., by facilitating access to radio coverage area adjustment information. As an example, radio coverage area adjustment information can facilitate decreasing the tilt of a base station antenna to decrease the radio coverage area and reduce overlap with other radio coverage areas of other radios. This example can therefore reduce interference between radios.

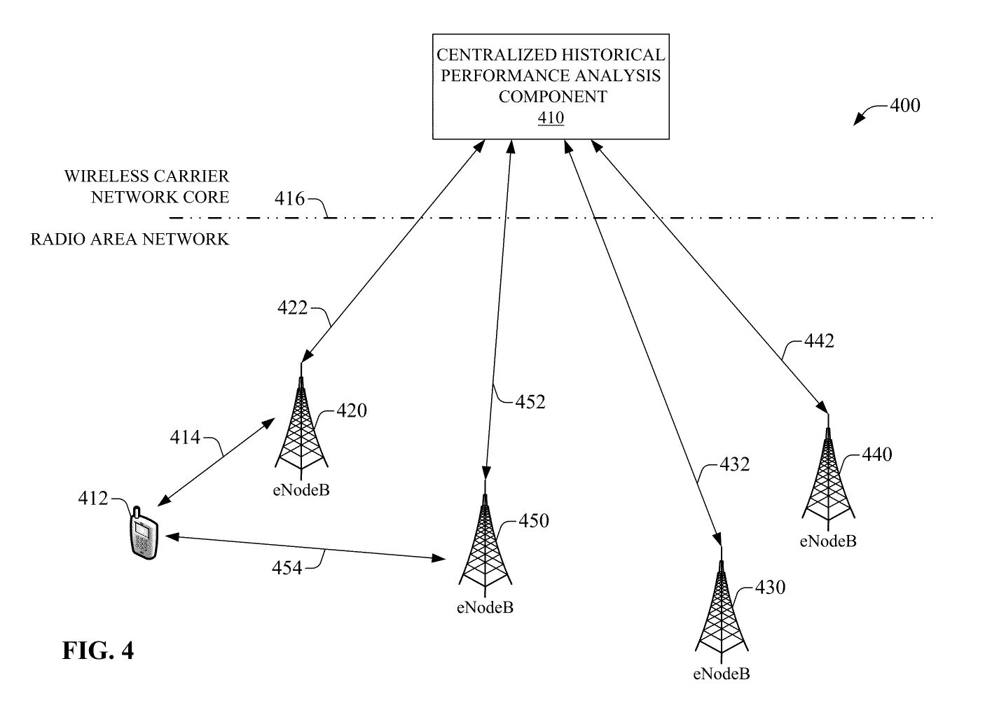

FIG. 4 is a graphic 400 of RAN conditions related to modification of neighbor relations based on centralized historic performance analysis of neighbor base stations in accordance with aspects of the subject disclosure. Graphic 400 illustrates several neighboring base stations, eNodeB 420, 430, and 440, communicatively coupled to HPAC 410 by way of communication links 422, 432, and 442 respectively. HPAC 410 can be located in a wireless carrier network core rather than being deployed in a RAN operated by the wireless carrier as illustrated by demarcation 416. HPAC 410 can determine neighbor relations information. Neighbor relations information can be employed to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc. Graphic 400 illustrates an example centralized deployment of HPAC 410 in contrast to the generally decentralized control structure more generally associated with locating control components in the RAN portion of a wireless carrier network, e.g., locating control components at eNodeBs of a RAN.

UE 412 can be served by eNodeB 420, as illustrated by communication link 414. eNodeB 420 can be communicatively coupled to HPAC 410 by communication link 422. As such, eNodeB 420 can facilitate HPAC 410 receiving radio identification information identifying eNodeB 420. Further, eNodeB 420 can facilitate HPAC 410 receiving radio identification information identifying neighbor relations for eNodeB 420, e.g., neighbor relations with eNodeB 430 and eNodeB 440. HPAC 410 can therefore determine neighbor relations information for eNodeB 420, 430, and 440 based on centralized historic performance analysis of neighbor base stations as disclosed herein. This neighbor relations information can be employed to update the neighbor relations among eNodeB 420, 430, and 440. As an example, a handover of UE 412 from serving base station eNodeB 420 to either eNodeB 430 or eNodeB 440 can typically be directed to the nearer base station (eNodeB 430) because handover between closer base stations can often be better than handover between more distant base stations due to attenuation of signal, etc. However, continuing the example, modification of neighbor relations based on centralized historic performance analysis of neighbor base stations can cause preferential selection of eNodeB 440 over eNodeB 430, even where eNodeB 430 is closer to eNodeB 420, for a handover of UE 412 from serving base station eNodeB 420 where eNodeB 440 has a higher determined historical performance than that of eNodeB 430.

Graphic 400 also includes eNodeB 450. eNodeB 450 can be a newly deployed base station of the RAN. eNodeB 450 can be detected by UE 412. UE 412 can report a new potential neighbor base station by way of communication link 414 to eNodeB 420. eNodeB 420 can make identification information for eNodeB 450 available to HPAC 410. Centralized historic performance analysis of eNodeB 450 can result in modification of neighbor relations of the RAN. As an example, eNodeB 450 can be added to a neighbor relations list and communication link 452 can be established. Where eNodeB 450 is added to the neighbor relations of eNodeB 420, handover of UE 412 to eNodeB 450 can be preferentially selected to establish communication link 454. As a further example, eNodeB 450 can be acknowledged but not put on a neighbor relations list in favor of keeping eNodeB 430 and eNodeB 440 as preferentially selectable neighbors to eNodeB 420 based on the historical performance of eNodeB 430 and eNodeB 440. Numerous other examples of modification of neighbor relations can be presented and are considered within the scope of the present disclosure but are reserved simply for reasons of clarity and brevity.

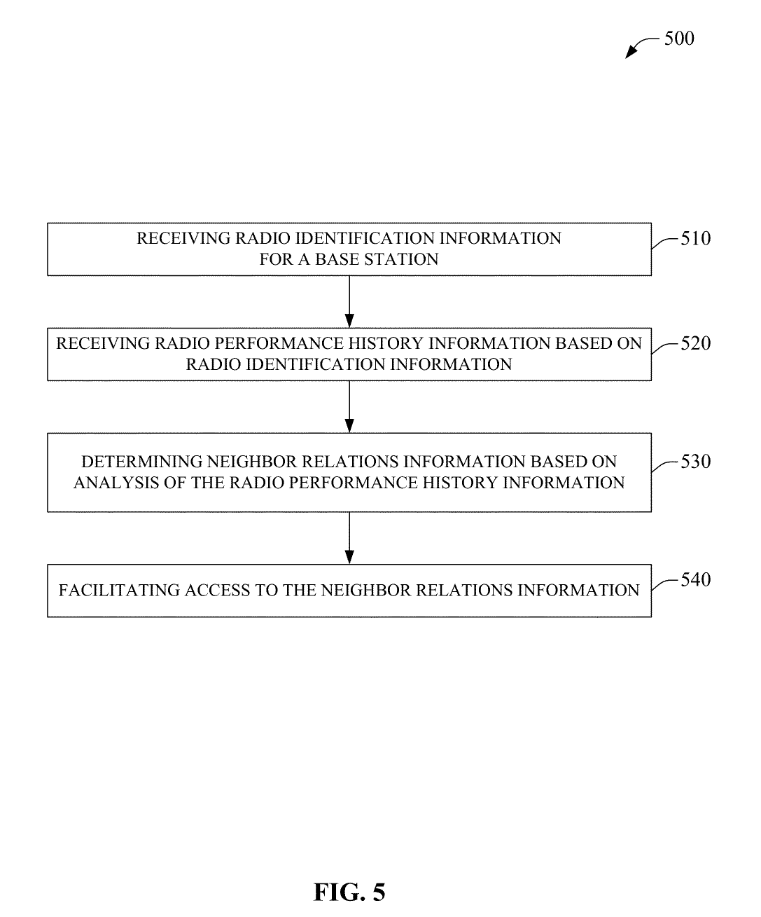

In view of the example system(s) described above, example method(s) that can be implemented in accordance with the disclosed subject matter can be better appreciated with reference to flowcharts in FIG. 5-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 5 illustrates aspects of method 500 facilitating modification of neighbor relations based on historic performance of neighbor base stations in accordance with aspects of the subject disclosure. At 510, radio identification information for a base station can be received. Radio identification information can include identification information for a wireless network base station, e.g., an eNodeB, etc. Identification information can include a PCI, a GCI, etc.

Radio identification information can further include neighbor relations information, e.g., neighbor base station relation information such as an ANR data structure in an LTE environment, etc. An ANR data structure can include information describing the topological relations of neighbor base stations of a wireless communications network. An ANR data structure can be, for example, in the form of a list, a table, etc. As an example, an ANR table can include information describing the topology of base stations neighboring a serving base station. Where, in the example, there are several neighbor base stations, the ANR table can include the preferential selection order of the neighbor base stations to preferentially select neighbor base stations for UE handover as a UE exits the coverage area of a serving base station. Selection of a high performing base station for handover can decrease the likelihood that the handover will fail severing the communication link with the UE.

At 520, radio performance history information based on radio identification information can be received. Radio performance history information can include historical performance information for a base station of a wireless communications network. In an aspect, radio identification information received at 510 can be employed to request radio performance history information corresponding to an identified base station. In an embodiment, method 500 can include radio performance history information being received from a data store, wherein the data store can be local or remote to a system receiving radio performance history information.

At 530, method 500 can include determining neighbor relations information based on analysis of the performance history information. Analysis can be related to a base station identified in radio identification information. As such, analysis can be related to base stations included in an ANR data structure. Analysis can include analysis to determine, for example, a high performing base station, ranking a base station, determining a poor performing base station, identifying a base station for a ‘black list’ or a ‘white list’, etc. Further, historical performance analysis can employ nearly any level of temporal granularity and nearly any combination of temporal periods. As examples, historical performance analysis can be based on sunny days, cloudy days, winter months, peak use days, etc. As further examples, historical performance analysis can be based on granularities of seconds, minutes, hours, days, weeks, months, etc. Furthermore, historical performance analysis can be event driven, for example, for weather events, sporting events, social events, emergency events, power outages, etc.

In an aspect, historical performance analysis can employ key performance indicators (KPIs). KPIs can include, but are expressly not limited to, call failure rate, call success rate, handover attempt count, handover attempt failure count, load indicia, etc. Further, historical performance analysis can include weighting. Weighting can be applied to individual KPIs, to combined KPI analysis, or combinations thereof.

In an aspect, profiles of base stations can be developed based on historical performance analysis. A base station profile can be made available in response to identification of a base station by way of receiving radio identification information at 510. The use of a profile can facilitate rapid employment of previously computed historical performance analysis for an indicated base station. Centralized historical performance analysis can readily compile profiles for one or more base stations in a RAN. These base station profiles can then be readily accessed to modify neighbor reactions information. Centralization of profile compilation can be advantageous over distributed profile development, e.g., development of profiles at each eNodeB for neighbors. A centralized profile can also reflect more complete analysis of relevant information.

At 540, access to the neighbor relations information can be facilitated. At this point, method 500 can end. Neighbor relations information, determined at 530, can be employed, by way of access related to 540, to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc.

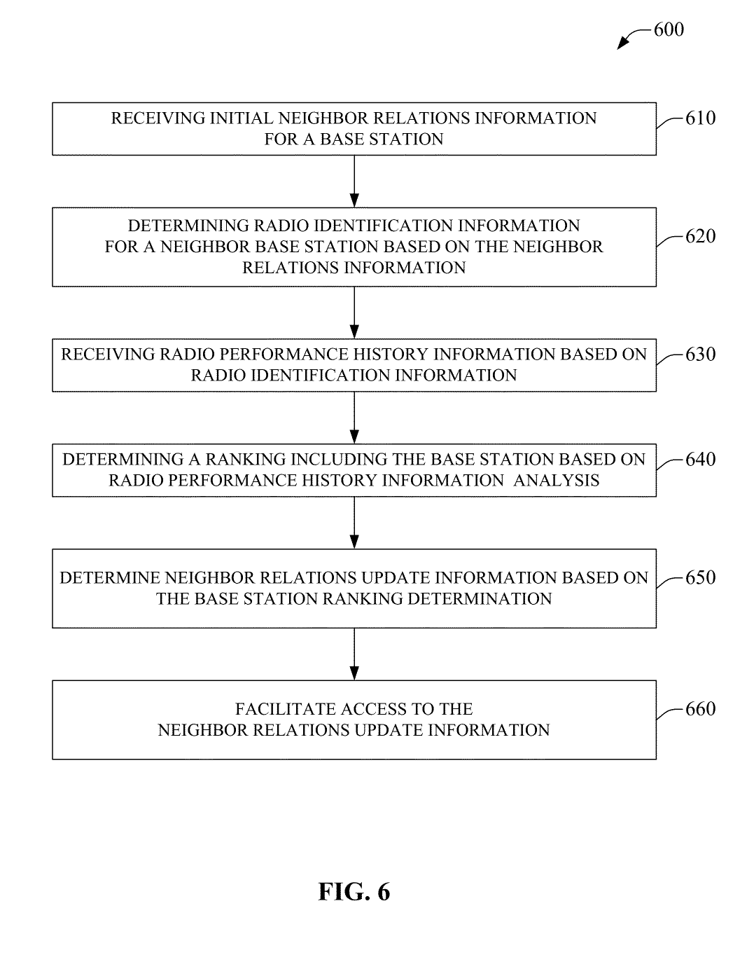

FIG. 6 illustrates aspects of method 600 facilitating modification of neighbor relations, including neighbor ranking, based on historic performance of neighbor base stations in accordance with aspects of the subject disclosure. At 610, method 600 can include receiving initial neighbor relations information for a base station. Initial neighbor relations information received at 610 can describe the topological relationship between base stations of a RAN. Neighbor base station relation information can include an ANR data structure in an LTE environment, etc. An ANR data structure can include information describing the topological relations of neighbor base stations of a wireless communications network. An ANR data structure can be, for example, in the form of a list, a table, etc. As an example, an ANR table can include information describing the topology of base stations neighboring a serving base station. Where, in the example, there are several neighbor base stations, the ANR table can include the preferential selection order of the neighbor base stations to preferentially select neighbor base stations for UE handover as a UE exits the coverage area of a serving base station. Selection of a high performing base station for handover can decrease the likelihood that the handover will fail severing the communication link with the UE.

At 620, radio identification information for a base station can be determined for a neighbor base station based on the initial neighbor reactions information received at 610. Radio identification information can include identification information for a wireless network base station, e.g., an eNodeB, etc. Identification information can include a PCI, a GCI, etc.

At 630, radio performance history information based on radio identification information can be received. Radio performance history information can include historical performance information for a base station of a wireless communications network. In an aspect, radio identification information determined at 620 can be employed to request radio performance history information corresponding to an identified base station.

At 640, determining a ranking including the base station can be based on analysis of radio performance history information received at 630. Analysis can be related to the base station identified in radio identification information from 620. As such, analysis can be related to base stations included in an ANR data structure. Analysis can include determining a ranking based on, for example, a high performance of a base station, a poor performance of a base station, placement of a base station on a ‘black list’ or a ‘white list’, etc. In an aspect, historical performance analysis can employ KPIs, including call failure rate, call success rate, handover attempt count, handover attempt failure count, load indicia, etc. Further, historical performance analysis can include weighting. Weighting can be applied to individual KPIs, to combined KPI analysis, or combinations thereof.

At 650, method 600 can include determining neighbor relations update information based on base station ranking determination at 640. Neighbor relations update information can reflect the ranking of base stations at 640. As such, modification of neighbor relations information based on neighbor relations update information can adapt the topology of based stations comprising RAN to preferentially select base stations for RAN events, including handover of UEs and establishing communication links, to reflect the ranking determined at 640 based on the performance history information analysis.

At 660, access to the neighbor relations information can be facilitated. At this point, method 600 can end. Neighbor relations information, determined at 650, can be employed, by way of access related to 660, to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc.

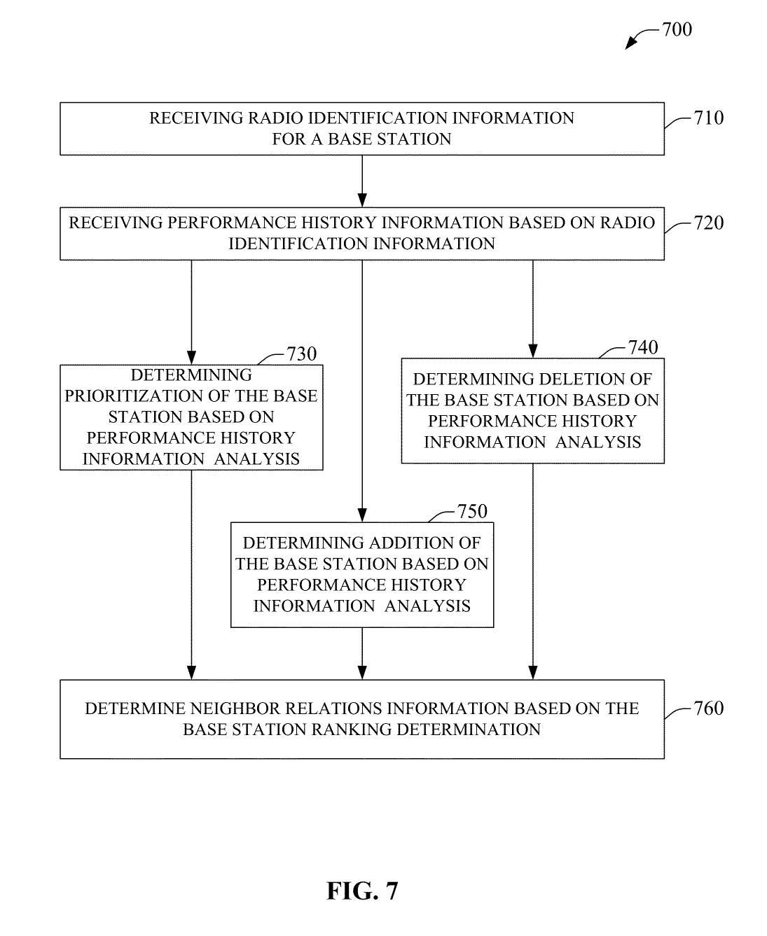

FIG. 7 illustrates a method 700 that facilitates modification of neighbor relations, including neighbor ranking, neighbor deletion, and neighbor addition, based on historic performance of neighbor base stations, in accordance with aspects of the subject disclosure. At 710, radio identification information for a base station can be received. Radio identification information can include identification information for a wireless network base station, e.g., an eNodeB, etc. Identification information can include a PCI, a GCI, etc. Radio identification information can further include neighbor relations information, such as an ANR data structure. An ANR data structure can include information describing the topological relations of neighbor base stations of a wireless communications network.

At 720, radio performance history information based on radio identification information can be received. Radio performance history information can include historical performance information for a base station of a wireless communications network. In an aspect, radio identification information received at 710 can be employed to request radio performance history information corresponding to an identified base station.

At 730, determining a prioritization of the base station can be based on analysis of radio performance history information received at 720. Analysis can be related to the base station identified in radio identification information from 710. As such, analysis can be related to base stations included in an ANR data structure. Analysis can include determining a prioritization for selection from a set of neighbor base stations. As an example, a highly prioritized base station would be more likely than a lower priority base station to be selected as a neighbor for a handover of a UE. In an aspect, historical performance analysis can employ KPIs, including call failure rate, call success rate, handover attempt count, handover attempt failure count, load indicia, etc. Further, historical performance analysis can include weighting. Weighting can be applied to individual KPIs, to combined KPI analysis, or combinations thereof.

At 740, determining deletion of the base station can be based on analysis of radio performance history information received at 720. Deletion of a base station from neighbor relations can be based on historical performance characteristics for the base station that make it an undesirable base station to keep as a neighbor base station. As an example, where the historical performance characteristics for the base station indicate that there are no successful handover attempts to the base station in the last two days despite numerous attempts, this can indicate a malfunction of the base station and it can be desirable to delete the base station from neighbor relations until it is repaired and brought back online.

At 750, determining addition of the base station can be based on analysis of radio performance history information received at 720. Addition of a base station to neighbor relations can be based on historical performance characteristics for the base station that make it a desirable base station to include as a neighbor base station. As an example, where the historical performance characteristics for the base station indicate that the base station was historically a high performing base station that has recently been offline for maintenance and that has now come back online, this can indicate that the base station is desirable as a neighbor base station and that it should be added to neighbor relations promptly.

At 760, method 700 can include determining neighbor relations information based on prioritization, deletion, or addition of the base station based on performance history information analysis. Modification of neighbor relations based on neighbor relations information can adapt the topology of based stations in a RAN to preferentially select base stations for RAN events, including handover of UEs and establishing communication links, to reflect the performance history information analysis determinations made at 730, 740, and 750.

In an aspect, profiles of base stations can be developed based on historical performance analysis. A base station profile can be made available in response to identification of a base station by way of receiving radio identification information at 710. The use of a profile can facilitate rapid employment of previously computed historical performance analysis for an indicated base station. Centralized historical performance analysis can readily compile profiles for one or more base stations in a RAN. These base station profiles can then be readily accessed to modify neighbor reactions information. Centralization of profile compilation can be advantageous over distributed profile development, e.g., development of profiles at each eNodeB for neighbors. A centralized profile can also reflect more complete analysis of relevant information.

Neighbor relations information, determined at 760, can be employed to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc.

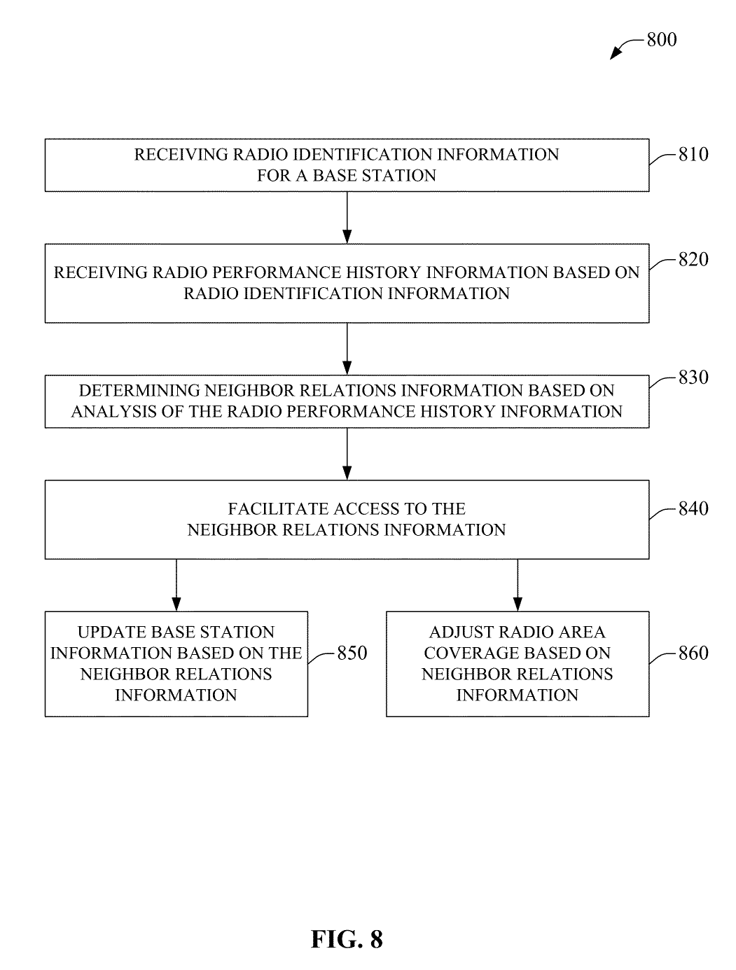

FIG. 8 illustrates a method 800 that facilitates modification of neighbor relations based on historic performance of neighbor base stations conflict resolution, and coverage area adjustment, in accordance with aspects of the subject disclosure. At 810, radio identification information for a base station can be received. Radio identification information can include identification information for a wireless network base station, e.g., an eNodeB, etc. Identification information can include a PCI, a GCI, etc. Radio identification information can further include neighbor relations information, such as an ANR data structure. An ANR data structure can include information describing the topological relations of neighbor base stations of a wireless communications network.

At 820, radio performance history information based on radio identification information can be received. Radio performance history information can include historical performance information for a base station of a wireless communications network. In an aspect, radio identification information received at 810 can be employed to request radio performance history information corresponding to an identified base station.

At 830, method 800 can include determining neighbor relations information based on analysis of the performance history information. Analysis can be related to a base station identified in radio identification information. As such, analysis can be related to base stations included in an ANR data structure. Analysis can include analysis to determine, for example, a high performing base station, ranking a base station, determining a poor performing base station, identifying a base station for a ‘black list’ or a ‘white list’, etc. Further, historical performance analysis can employ nearly any level of temporal granularity and nearly any combination of temporal periods.

At 840, access to the neighbor relations information can be facilitated. At 850, base station information can be updated based on the neighbor relations information. Neighbor relations information, determined at 830, can be employed, by way of access related to 840, to modify the preferential selection of a neighbor base station, add a base station, delete a base station, flag a base station, black-list or white-list a base station, etc. In an aspect, neighbor relations information can be associated with modification of an ANR data structure, e.g., an ANR list can be update to reflect new neighbor base stations, remove existing neighbor base stations, reorder base station selection preference order of the ANR list, etc.

At 860, radio area coverage can be adjusted based on neighbor relations information. At this point, method 800 can end. Radio area coverage can be updated to change elevation, azimuth, transmission power, etc., or a radio of a base station. As an example, adaptation of radio coverage area of a base station can reduce overlap with other radio coverage areas of other radios. This, for example, can reduce interference between radios. Where neighbor relations are updated based on neighbor relations information, adjustment of a radio area coverage can be a desirable action, for example, where a base station is removed from neighbor relations, it can be desirable to adjust the coverage area of other neighbors to sufficiently cover portions of the area previously covered by the removed base station.

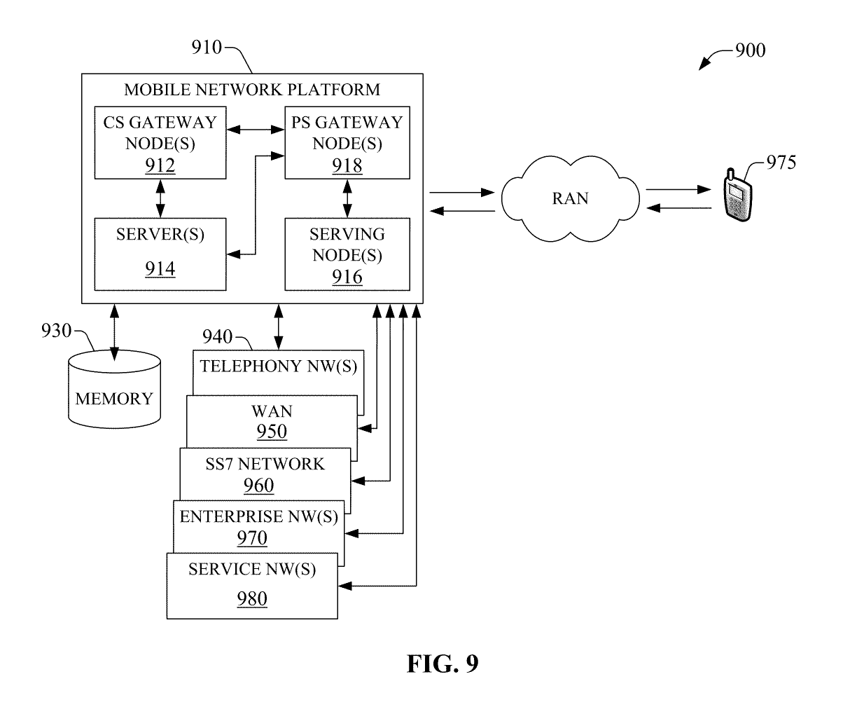

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 970; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 960 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload RAN resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore. In an example embodiment, radio performance history store 352 can be included on server 914.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 960, or SS7 network 970. In an aspect, memory 930 can be, for example, accessed as part of a data store component or as a remotely connected memory store, such as radio performance history store 352 can be included in memory 930.

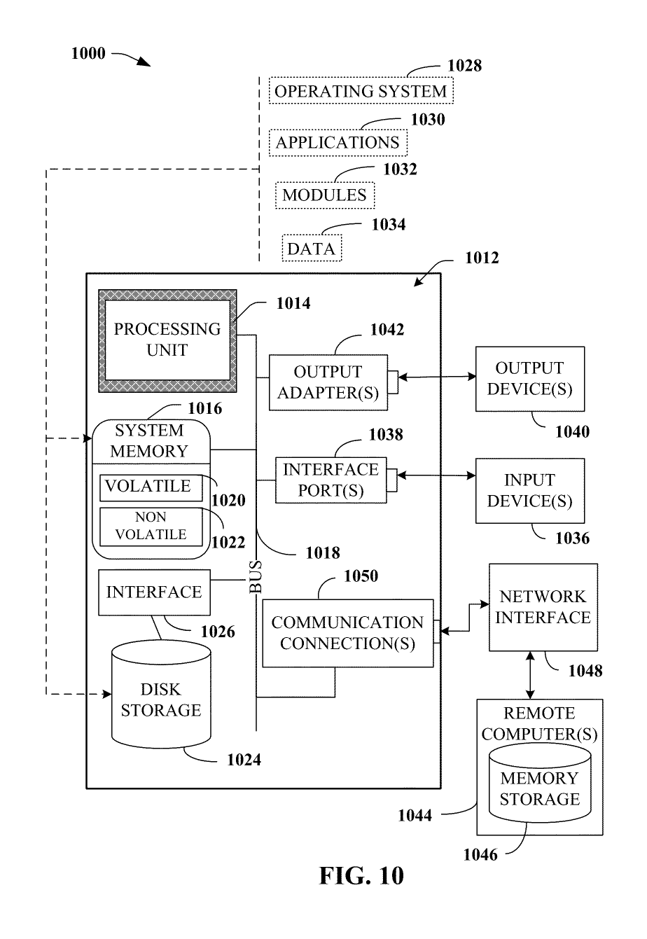

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of a mobile reporting component or UE (e.g., UE 412, HPAC 110, 210, 310, 410, base station 220, 320, radio performance history store 352, etc.), a RAN component (e.g., base station 420, 430, 440, 450, etc.), a response component (e.g., radio performance history store 352), etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile reporting component 250 can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “Node B,” “evolved Node B (eNode B),” “home Node B (HNB),” “home access point (HAP),” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A system, comprising:
a memory to store executable instructions; and
a processor, coupled to the memory, that facilitates execution of the computer-executable instructions to perform operations, comprising:
receiving radio information related to an identification of a radio in a wireless communications system;
receiving historical performance information related to the radio and related to a performance indicator;
determining an update for neighbor base station relation information, based on an analysis of the historical performance information, to facilitate an adaptation of a coverage area of the wireless communication system based on relation information for a set of neighbor base station relations, wherein the update comprises a rank update for a rank ordering of the set of neighbor base station relations; and
facilitating access to the update for the neighbor base station relation information.

2. The system of claim 1, wherein the neighbor base station relation information is stored in a data structure including data representing the set of neighbor base station relations and the update for the neighbor base station relation information facilitates a modification of the data.

3. The system of claim 1, wherein the adaptation of the coverage area includes management of a data structure including data representing the set of neighbor base station relations including a deletion of an identity of a neighbor base station from the data representing the set of neighbor base station relations.

4. The system of claim 1, wherein the adaptation of the coverage area includes management of a data structure including data representing the set of neighbor base station relations including an addition of an identity of a neighbor base station to the data representing the set of neighbor base station relations.

5. The system of claim 1, wherein the adaptation of the coverage area includes management of a data structure including data representing the set of neighbor base station relations including a prioritization of an identity of a neighbor base station of the data representing the set of neighbor base station relations based on the rank update of the rank ordering.

6. The system of claim 1, wherein the historical performance information includes a value related to a successful establishment of a communication link between a user equipment and the radio.

7. The system of claim 1, wherein the historical performance information includes a value related to an unsuccessful establishment of a communication link between a user equipment and the radio.

8. The system of claim 1, wherein the historical performance information includes a value related to a successful handover of a user equipment to the radio or from the radio.

9. The system of claim 1, wherein the historical performance information includes a value related to unsuccessful handover of a user equipment to the radio or from the radio.

10. The system of claim 1, wherein the update is determined in part by a first application of a predetermined rule, related to a predefined performance of the radio, to the historical performance information.

11. The system of claim 10, wherein the update is determined in part by a second application of the predetermined rule to the historical performance information, wherein the historical performance information includes a first performance indicator and a weighted second performance indicator that applies a weighting factor that adjusts an effect of the weighted second performance indicator in the second application of the predetermined rule relative to the first performance indicator in the first application of the predetermined rule.

12. A method, comprising:
receiving, by a system including a processor, radio identification information for a base station device of a wireless communications network, wherein the base station device is a neighbor base station device to a serving base station device;
receiving, by the system, historical performance information related to the base station device and related to a performance indicator;
determining, by the system, an update for neighbor base station relation information, based on analyzing the historical performance information, wherein the update comprises a refreshed preference ordering of a set of neighbor base station relations associated with the serving base station device;
facilitating, by the system, adapting a coverage area of the wireless communication system based on the update and relation information for the set of neighbor base station relations; and
facilitating, by the system, access to the update for the neighbor base station relation information.

13. The method of claim 12, wherein the analyzing the historical performance information includes analyzing a value related to establishing a communication link between a user equipment and the base station device.

14. The method of claim 12, wherein the analyzing the historical performance information includes analyzing a value related to a handover of a user equipment between the serving base station device and the base station device.

15. The method of claim 12, wherein the determining the update includes applying a predetermined rule, related to a defined performance of the radio, to the historical performance information.

16. The method of claim 12, wherein the facilitating the adapting of the coverage area includes facilitating deleting the first base station device from, or facilitating adding the first base station device to, a data structure representing the set of neighbor base station relations.

17. The method of claim 12, wherein the facilitating the adapting of the coverage area includes facilitating prioritizing a neighbor base station device represented in a data structure defining the set of neighbor base station relations based on the refreshed preference ordering.

18. A device, comprising:
a memory executable instructions; and
a processor, coupled to the memory, that facilitates execution of the executable instructions to perform operations, comprising:
receiving initial neighbor base station relation information related to a base station device of a wireless communications network, wherein the base station device is a neighbor base station device to a serving base station device;
receiving historical performance information related to the base station device;
determining an update for neighbor base station relation information, wherein the update comprises a revised rank of a set of neighbor base station relations, based on an analysis of the historical performance information, to facilitate an adaptation of a topology of the wireless communication system based on the set of neighbor base station relations; and
facilitating access to the update for the neighbor base station relation information.

19. The device of claim 18, wherein the update is determined in part by an application of a predetermined rule to the historical performance information.

20. The device of claim 18, wherein the update for the neighbor base station relation information is determined based on a determination of a priority of the base station device with regard to a rank of another base station device represented in the set of neighbor base station relations, the neighbor base station relation information is stored in a data structure representing the set of neighbor base station relations, and the update for the neighbor base station relation information facilitates a modification of the data structure to include information representative of the determination of the priority.
